(19) United States
(12) Patent Application Publication
(10) Pub. No.: US 2004/0073575 A1
(43) Pub. Date: Apr. 15, 2004

(54) Updatable personalized talking device

(76) Inventor: John Locke, Ventura, CA (US)

Correspondence Address: Christopher J. McDonald, Mitchell, Silberberg & Knupp, 11377 West Olympic Boulevard, Los Angeles, CA, 90064-1683, US

(21) Appl. No.: 10/460,159

(22) Filed: Jun. 13, 2003

Related U.S. Application Data
(60) Provisional application No. 60/387,896, filed on Jun. 13, 2002.
(60) Provisional application No. 60/387,897, filed on Jun. 13, 2002.

(51) Int. Cl. G06F 7/00

(52) U.S. Cl. 707/104.1

(57) ABSTRACT

The system has three main parts. The first is a service providing audio and visual data downloaded for the user. The service provides a library of audio files including words, phrases and complete stories. The database of audio files can be updated. The second component is a software application for a user's computer. The application provides users with the software necessary to connect to the service, to provide personalizing information, select audio and visual files, purchase and download the files from the service. The third component is a device for playing the audio and visual files with the ability to display animated characters on a screen corresponding to the audio files being played. The screen has the ability to allow the user to color characters similar to a coloring book.

This application claims the benefit of provisional patent application Serial No. 60/387,896, filed Jun. 13, 2002 and Serial No. 60/387,897, filed Jun. 13, 2002.

### FIELD OF THE INVENTION

The invention relates to a device capable of playing audio files containing personalized information unique for the user.

### BACKGROUND OF THE INVENTION

Devices that are able to play audio files for the amusement of the user are well known. These devices are normally embodied in “talking books” and toys. These audio files are stored in the device or on a cassette, disk or other separable memory device inserted into the device. When on a separable memory device, an unlimited number of audio files can be played through the device.

It is often necessary to add features to such devices to make them more attractive to the user. Any feature enhancing the user's interest makes the device more commercially appealing and successful.

It is an object of the invention to provide a device playing audio and/or video files personalized for the user.

It is another object of the invention to provide a service having a library of audio and visual files accessible by the user.

It is still another object of the invention to provide software enabling the user to access a library of audio and visual files.

It is yet another object of the invention to provide a library of audio and visual files accessed through the Internet.

It is still yet another object of the invention to provide a device for playing the personalized audio and visual files for the user.

These and other objects of the invention will become apparent to one of ordinary skill in the art after reviewing the disclosure of the invention.

### SUMMARY OF THE INVENTION

The system has three main parts. The first is a service providing audio and visual data downloaded for the user. The service provides a library of audio files including words, phrases and complete stories. The database of audio files can be updated. The second component is a software application for a user's computer. The application provides users with the software necessary to connect to the service, to provide personalizing information, select audio and/or visual files, purchase and download the files from the service. The third component is a device for playing the audio and visual files with the ability to display animated characters on a screen corresponding to the audio files being played. The screen has the ability to allow the user to color characters similar to a coloring book. This is part of the personalization process.

In a first embodiment, the audio files include complete stories with video files corresponding to the action of the story. The device is a “talking book”. In a second embodiment, the audio files are word segments and phrases and the device for playing them is a toy.

### BRIEF DESCRIPTION OF THE DRAWINGS

FIG. 1 is a flow diagram for the service providing audio and visual files;

FIG. 2 is a flow chart showing the use of the service by a user; and

FIG. 3 is a diagram showing a relationship between the device playing the audio and visual files and the user's computer.

### DETAILED DESCRIPTION OF THE DRAWINGS

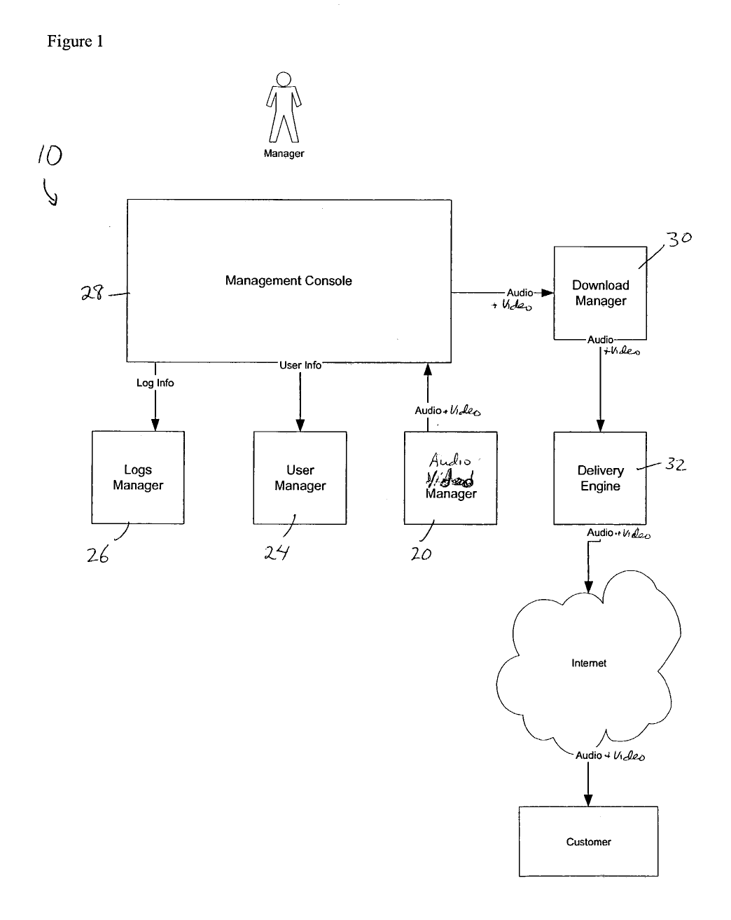

Referring to FIG. 1, a flow diagram displays the service 10 storing and providing a library of audio and visual files to a user. Library stories and any new stories created and added to the library are stored in the audio and visual manager 20. Users access the service through the internet, allowing the user to provide personalized information to the service which is saved in the User Manager 24. Personalized information includes information supplied by the user regarding information unique to the user. Personalized information includes names, ages, number of siblings, address, pet's names and other personalized information. The User Manager, also stores the user's account information such as contact information, billing information and credit card information. The user selects and downloads a file. The log manager 26 records a transition for proper record keeping and billing. The management console 28 coordinates the audio visual manager 20, user's manager 24 and log manager 26. The Management Console takes the selected file from the audio visual manager 20, the user's personal information from the User Manager 24 and personalizes the file by selecting words and phrases from the prerecorded Library and using a Text-to-Speech Engine. Once personalized, the file is sent to the download manager 30. Download Manager places the personalized file in a queue and sends it to the Delivery Engine that in turn delivers the personalized file to the user via the internet.

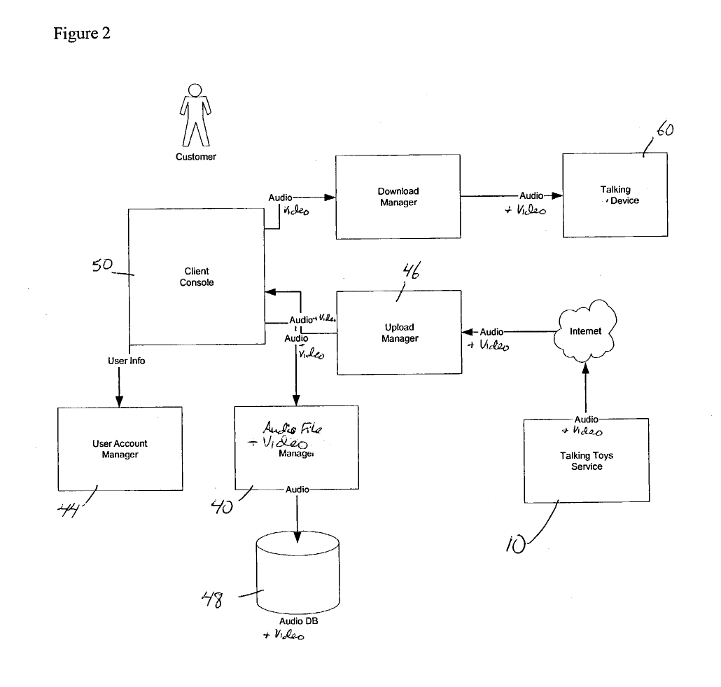

The second feature of the system is the software application allowing the user to access the service providing the personalized stories. FIG. 2 shows the interaction between the client's software and the service 10. The software application allows the user to connect to the service 10 through the internet. The user provides information for billing purposes along with initially providing personal information used to personalize the files for download. As mentioned previously, personalized information provided by the client is stored in the Service User Manager 24. In addition, this information is stored in the Client User Account Manager 44. The client console 50, such as a personal computer, also operates an Upload Manager 46 for connecting to the service 10 and a Files Manager 40 for storing downloaded files. The user selects a file from the service and downloads the personalized file which may be saved in the file database 48.

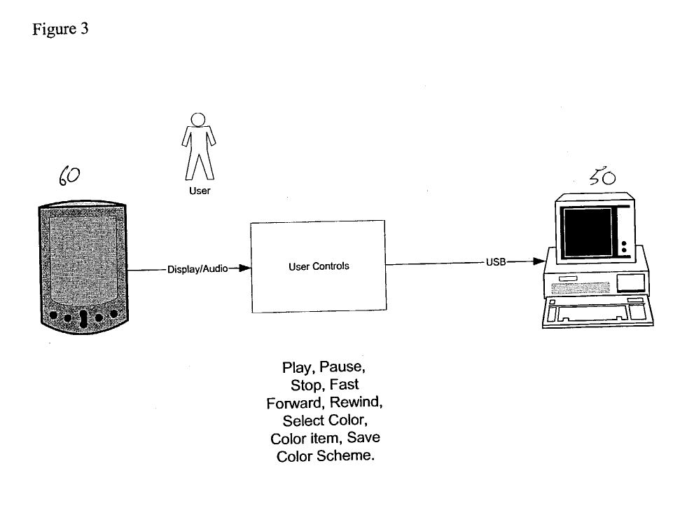

FIG. 3 shows the user's handling of the downloaded file. A USB cable or other type of transfer device is used to load the file to a device 60 for playing the audio and visual files. In a first embodiment of the invention, the audio and visual files are complete stories. These stories may be downloaded to a “talking book” or to a personal digital assistant (PDA) equipped to play audio and visual files in such format as MP3. The display of the PDA or the talking book will run the video files corresponding to the story. When using a PDA as the device to play the audio files, the MP3 is the preferred format for the audio files.

The user will have the capability of coloring the video before the video files run. Controls on the “talking book” or a PDA will allow the user to control the files with such commands as play, pause, stop, fast forward, rewind, select color, color item and save color scheme. The user selects the color they want and the portion of the character to be coded. The process of selecting color and the portion of the character is repeated until all portions of the characters have been colored. Once the user is satisfied with the color scheme chosen, the user saves the color scheme. At this time, the user chooses to play the audio story and the video corresponding to the audio is played concurrently.

In a second embodiment of the invention, the audio files are words and phrases which are personalized. In this instance, the files are downloaded to a talking toy device. The talking toy can take the form of any shape such as an animal. The phrase spoken by the toy may be in response to external stimulus applied to the toy by the user. For instance, moving the toys legs will cause the toy to say “Let's go run, [name inserted]” and a hug will cause the toy to say “I love you, [name inserted]”. The user may assign a phrase to a particular external stimulus when it is downloaded to the toy.

While the invention has been disclosed in reference to a preferred embodiment, variations and modifications would be apparent to one of ordinary skill in the art. The disclosure encompasses such variations and modifications without departing from the spirit of the invention. For instance, the user may also choose to play the story and video files through the personal computer used in accessing the service.

What is claimed is:

1. A system for providing personalized audio files, comprising:
a library of audio files,
a database of personalized information of users,
said personalized information for a particular user merged into an audio file selected by a user, and
a device for playing the personalized audio file.

2. The system of claim 1, wherein said audio files are complete stories.

3. The system of claim 1, wherein said audio files are words and phrases.

4. The system of claim 1, wherein said device is a talking book

5. The system of claim 1, wherein said device is a toy.

6. The system of claim 5, wherein specific audio files are played in response to specific external stimulus applied to the toy.

7. The system of claim 1, further comprising software enabling a user to access and download said audio files over the internet.

8. The system of claim 1, further comprising a log manager recording activity for each user.

9. A method of creating personalized audio files, comprising:
providing a library of audio files
providing a database of personalized information for a plurality of users,
merging said personalized information for a particular user into said audio files, and
sending said personalized audio files to said particular user.

10. The method of claim 9, further comprising accessing said library and downloading said audio files through the internet.

11. The method of claim 10, wherein merging said personalized information with said audio file before downloading.
